(19) United States
(12) Patent Application Publication
(10) Pub. No.: US 2005/0071457 A1
(43) Pub. Date: Mar. 31, 2005

(54) System and method of network fault monitoring

(76) Inventors: Siew-Hong Yang-Huffman, Loveland, CO (US); Maurice Labonte, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/649,303

(22) Filed: Aug. 27, 2003

(51) Int. Cl. G06F 15/173

(52) U.S. Cl. 709/224; 709/220

(57) ABSTRACT

A system and method for monitoring network condition comprises a policy server operable to generate collection configuration information based on network topology information and at least one collection policy, and at least one collector operable to access the collection configuration information and operable to poll a subset of network nodes requiring monitoring according to the collection configuration information.

### TECHNICAL FIELD OF THE INVENTION

The present invention relates generally to the field of networks, and more particularly to a system and method of network fault monitoring.

### BACKGROUND OF THE INVENTION

A data communications network generally includes a group of devices, such as computers, repeaters, bridges, routers, cable modems, etc., situated at network nodes and a collection of communication channels or interfaces that interconnect the various nodes. Hardware and software associated with the network and devices on the network permit the devices to exchange data electronically via the communication channels. The size of a data communications network can vary greatly. A local area network, or LAN, is a network of devices in close proximity, typically less than a mile, that are usually connected by a single cable, such as a coaxial cable. A wide area network (WAN), on the other hand, is a network of devices separated by longer distances and often connected by telephone lines or satellite links, for example.

An industry standard for data communication in networks is the Internet Protocol (IP). This protocol was originally developed by the U.S. Department of Defense, and has been dedicated to public use by the U.S. government. In time, the Transmission Control Protocol (TCP) and the User Datagram Protocol (UDP) were developed for use with the IP. The TCP/IP protocol is a protocol that implements certain check functionality and thus guarantees transfer of data without errors. The UDP/IP protocol does not guarantee transfer of data but it offers the advantage of requiring much less overhead than does the TCP/IP protocol. Moreover, in order to keep track of and manage the various devices situated on a network, the Simple Network Management Protocol (SNMP) was eventually developed for use with the UDP/IP platform. The use of these protocols has become extensive in the industry, and numerous vendors now manufacture many types of network devices capable of operating with these protocols.

In a network managed by SNMP, data about network elements are stored in a Management Information Base (MIB). MIB data is typically populated into tabular form according to SNMP standards, and provides requested network information to processes such as an Internet usage mediation software or system. In a particular embodiment, active nodes or devices are identified by their IP address on a network, which may be included in MIB data. Once an element is configured on the network, the network mediation software may retrieve relevant network acting information or statistics about that element. The network mediation software is a platform available to gather and/or filter desired usage information from network devices such as routers, switches, servers, and gateways that implement a variety of protocols. Such system or software may be used by telephone companies, Internet service providers, and other entities that require timely and responsive network information to obtain an overview of the network for purposes such as usage billing, marketing analysis, and capacity planning.

One desirable capability of a conventional network management system is to discover network topology. A network management system is operable to generate a list of all network devices or nodes in a domain, their type, and their connections. A network management system may also perform network monitoring functions. The network management system periodically polls all the network nodes and gathers data that is indicative of each node's health or operating status. Because existing network management systems periodically poll each network device, extra network traffic is generated by this activity. In some networks, this polling activity can dramatically increase the amount of network traffic.

### SUMMARY OF THE INVENTION

Therefore, there is a desire to monitor the health of a network without adding significant volume to network traffic. In accordance with an embodiment of the present invention, a system and method for monitoring network condition comprises a policy server operable to generate collection configuration information based on network topology information and at least one collection policy, and at least one collector operable to access the collection configuration information and operable to poll a subset of network nodes requiring monitoring according to the collection configuration information.

In accordance with another embodiment of the invention, a method for monitoring a network of a plurality of network nodes comprises receiving network topology information, receiving a definition of a subset of network nodes from which to collect data and a definition of the type of data to collect, generating collection configuration information in response to the network topology information, definition of the subset of network nodes and definition of the type of data, and collecting data from the subset of network nodes according to the collection configuration information.

In accordance with yet another embodiment of the present invention, a system for network monitoring comprises means for receiving network topology information, means for receiving a definition of a subset of network nodes from which to collect data and a definition of the type of data to collect, means for generating collection configuration information in response to the network topology information, definition of the subset of networks nodes and definition of the type of data, and means for collecting data from the subset of network nodes according to the collection configuration information.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an embodiment of a system of network fault monitoring according to the present invention; and

FIG. 2 is a flowchart of an embodiment of a method of network fault monitoring according to the present invention.

### DETAILED DESCRIPTION OF THE DRAWINGS

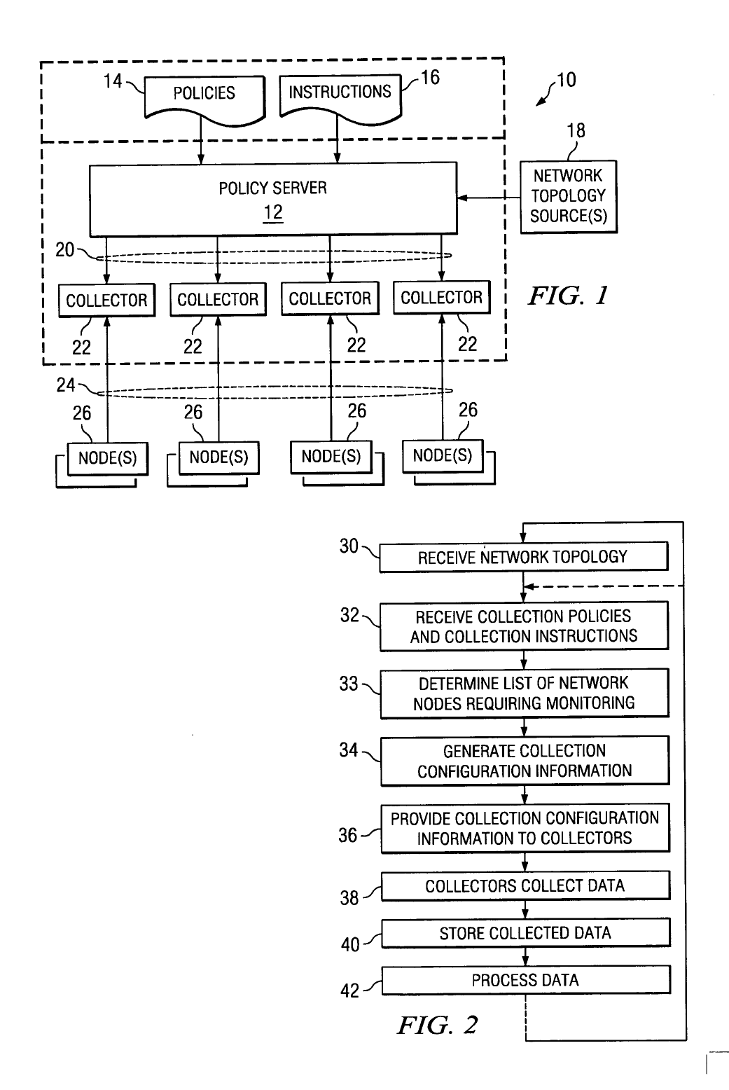

The preferred embodiment of the present invention and its advantages are best understood by referring to FIGS. 1 and 2 of the drawings, like numerals being used for like and corresponding parts of the various drawings.

FIG. 1 is a block diagram of an embodiment of a system of network fault monitoring 10 according to the present invention. System 10 may comprise or be a component of an Internet usage mediation system and/or software. One example of an embodiment thereof is the OpenView Internet Usage Monitor (IUM) from Hewlett-Packard Company of Palo Alto, Calif., that collects data related to the use of network resources for billing purposes. System 10 comprises a policy server 12 that is operable to receive or access collection policies 14 and collection instructions 16. Collection policies 14 provide a definition of criteria to be applied to the set of nodes or elements in the network to collect data. Collection policies 14 may establish criteria for collection based on, for example, the Internet Protocol (IP) addresses, device types, database values and/or management information base (MIB) object values of the network nodes. The collection policies are used by policy server 12 to filter out network nodes that are functioning normally which do not require monitoring or data collection. Therefore, a subset of network nodes are targeted for fault monitoring depending on the collection policy. Collection instructions 16, on the other hand, describe the types of data to collect from nodes defined by the collection policies. Collection instructions 16 may specify, for example, the set of MIB objects to collect, the polling interval, device access information and where to store the collected data. A user may formulate a collection policy and/or a collection instruction by using an editor, graphical or otherwise, and store the collection policy and instruction in a data store accessible by policy server 12.

Policy server 12 also receives or has access to network topology information from one or more network topology sources 18. Network topology sources 18 are hardware or software inventory proxies, which may comprise databases and/or network discovery software such as OpenView Network Node Manager from Hewlett-Packard Company. Network topology sources 18 are operable to provide updated network topology information to policy server 12. Network topology sources 18 are also operable to receive traps or other messages from network nodes that experience changes in operating status that require attention. Network topology sources 18 are operable to provide a list of active nodes existing in the network, and/or provide a list of network nodes that require closer monitoring. It should be noted that the words “nodes,” “devices,” and “elements” are used interchangeably herein to reference components that are linked together by a network.

Policy server 12 is further in communications with at least one collector 22. Collectors 22 are operable to continuously collect status information 24 from a plurality of network devices or nodes 26 that make up a network. Policy server 12 is operable to indicate to collectors 22 which network nodes to target for data collection. In one embodiment of a network mediation system or software, collectors 22 are operable to collect network usage data for the primary purpose of generating billing information. However in this embodiment of the invention, collectors 22 are also operable to collect data related to operating status or states of the network nodes for the primary purpose of fault monitoring. The billing information may be modified or generated in response to the operating status of the network nodes. For example, a bill may be reduced in response to a particular network node not operating properly all of the time.

Referring also to FIG. 2 for a flowchart of an embodiment of a method of network fault monitoring according to the present invention, policy server 12 receives the network topology information from network topology sources 18, as shown in block 30. Policy server 12 communicates with one or more network topology sources 18 to obtain a list of nodes that exist in the network. Alternatively, network topology sources 18 may provide data on those network nodes that require attention due to their deteriorating operating condition or other reasons. Network topology sources 18 may include a software process which automatically discovers the operating nodes in a network, a record or file in a database, or a table stored in a data storage devices, etc. For example, a network topology database may comprise a list of all network nodes, but with a specific field or flag set for monitoring. As shown in blocks 32 and 33, policy server 12 receives or accesses collection policies 14 and collection instructions 16 to determine and finalize a list of network nodes to monitor, the type of data to collect, and other data related to data collection. Policy server 12 may use collection policies to filter out nodes that are functioning normally thus not requiring monitoring. For example, a collection policy may specify all network nodes that has an Internet Protocol address containing a particular number sub-string are targets, or that all network devices of a particular type are targets. As a result, only a subset of the network nodes are targeted for fault monitoring. As an example, collection policies and instructions may be of the following format:

[/CollectionPolicy/Policy_1]
UseCollectionGroup=Group_1
Test=IP,*,AND TRAP NOT NULL
[/CollectionPolicy/Policy_2]
UseCollectionGroup=Group_2
Test=IP,15.11.129.18-15.11.129.19
[/CollectionInstructions/Group_1]]
SnmpNMEFieldMap=RouterId,.1.3.6.1.2.1.2.2.1.2,DISPLAYSTR
SnmpNMEFieldMap=OperStatus,.1.3.6.1.2.1.2.2.1.8,INTEGER
SnmpQueryInterval=15min
SnmpVersion=1
[/CollectionInstructions/Group_2]]
SnmpNMEFieldMap=RxBytes,.1.3.6.1.2.1.2.2.1.10,COUNTER32
SnmpQueryInterval=15min
SnmpRetriesNumber=3
SnmpTimeOut=5seconds
SnmpVersion=1

In the above example, the first collection policy, Policy_{—}1, to be used on devices associated with collection group Group_{—}1, is an Internet Protocol address AND some specified condition such as “TRAP not null”. The second collection policy, Policy_{—}2, applied to devices associated with a collection group called Group_{—}2, is device(s) with the Internet Protocol address that fall within the range specified in the example. Each collection policy refers to one or more collection groups, which may specify a group of routers, cable modems, or other network devices, for example. The next paragraph, specifying collection instructions for Group_{—}1, indicates the variable, attribute and type to associate with the collected object value—the router identifier (RouterId), the MIB object identifier (1.3.6.1.2.1.2.2.1.2) and the data type for the collected object value, (string). Collection instructions may further describe where the collected data are to be stored. The next data item to be collected in the example is the operating status of the device, OperStatus. The collection instruction further specifies when or a time interval for collecting the specified data with the SnmpQueryInterval variable. Alternatively, a calendar-based polling schedule, CronInterval, may be specified. For example, the CronInterval variable may be set to indicate polling at a specific day of the week, month, date, hour, and/or minute. In addition to SnmpQueryInterval, Group_{—}2 provides additional information as to how to obtain data from the associated devices. SnmpRetriesNumber specifies the number of retries when an attempt to obtain data failed. SnmpTimeOut specifies the time to wait for a response. It should be noted that although the description herein references SNMP, embodiments of the invention are also applicable to other network management protocols now known or to be developed.

In block 34, policy server 12 generates collection configuration information based on the network topology, collection policies and collection instructions. The configuration information is provided to at least one collector 22, as shown in block 36. The configuration information may be in the form of assigned node files, and specifies which nodes are assigned to which collector for data collection purposes. The assigned node files specify a subset of nodes to be polled and the set of MIB variables to be extracted. Each node in the assigned node file is identified, preferably by its Internet Protocol address. Policy server 12 may store the configuration information at predetermined locations in a database or some other data storage device for access by collectors 22. Each collector 22 may access a different data field or location to obtain the configuration information. Collectors 22 are responsible for targeting assigned network nodes for data collection and the network nodes assigned to the collectors may overlap. Because network topology and network operating status may change, collectors 22 periodically reload the configuration information to ensure that they have the most recent information for data collection. Collectors 22 then collect data as described in the configuration information from its assigned nodes, as shown in block 38. In blocks 40 and 42, the collected data is stored according to the configuration information and this data is processed. The collected data may be used in billing generation processes or for network health status, for example.

Among the data collected by collectors 22 are traps or messages from network devices indicating a need for attention or a change in operating status. This information is provided to network topology sources 18 and/or policy server 12 so that the configuration information generated by policy server 12 may include the particular network device for close monitoring, as indicated by the dashed line in FIG. 2. If the network topology source comprises a database, the relevant fields or flags of the network nodes requiring attention or close monitoring may be set to a predetermined value. Therefore, the collection configuration information generated by policy server 12 takes into account which nodes need closer monitoring and may not always encompass all the nodes in the network.

Thus, instead of routinely polling all the nodes in a network, system 10 polls only those network nodes that require monitoring due to changes in a node's operating status or some other predetermined reason. For example, system 10 may only poll routers that are operating at less than 50 % level, network nodes that experience a reduced throughput, or network nodes that are associated with a particular customer that are not operating optimally. The amount of added traffic volume to the network due to fault monitoring is therefore significantly reduced. Embodiments of the present invention are also dynamically adaptable to changing network configurations and topology.

System 10 may be part of an Internet usage mediation system and/or software, which typically collects data associated with the usage of network resources. The fault monitoring data may be used to generate billing information for the use of the network resources. The billing information may reflect the operating status of one or more network nodes used by a customer, for example. System 10 is operable to passively and non-invasively provide fault monitoring of the network by limiting the resources needed to poll all of the network nodes.

1. A system for monitoring network condition, comprising:
a policy server operable to generate collection configuration information based on network topology information and at least one collection policy; and
at least one collector operable to access the collection configuration information and operable to poll a subset of network nodes requiring monitoring according to the collection configuration information.

2. The system, as set forth in claim 1, wherein the at least one collection policy defines the subset of network nodes requiring monitoring.

3. The system, as set forth in claim 1, wherein the at least one collection policy defines the Internet Protocol of the subset of network nodes requiring monitoring.

4. The system, as set forth in claim 1, wherein the at least one collection policy defines a device type of the subset of network nodes requiring monitoring.

5. The system, as set forth in claim 1, wherein the policy server is further operable to generate collection configuration information based on at least one collection instruction, the collection instruction defines what data is to be collected from the subset of network nodes requiring monitoring.

6. The system, as set forth in claim 1, wherein the policy server is further operable to generate collection configuration information based on at least one collection instruction, the collection instruction defines how data is to be collected from the subset of network nodes requiring monitoring.

7. The system, as set forth in claim 1, wherein the policy server is further operable to generate collection configuration information based on at least one collection instruction, the collection instruction defines the frequency to collect data from the subset of network nodes requiring monitoring.

8. The system, as set forth in claim 1, wherein the policy server is further operable to generate collection configuration information based on at lease one collection instruction, the collection instruction defines when to collect data from the subset of network nodes requiring monitoring.

9. The system, as set forth in claim 1, wherein the policy server is further operable to generate collection configuration information based on at least one collection instruction, the collection instruction defines how to store data collected from the subset of network nodes requiring monitoring.

10. A method for monitoring a network of a plurality of network nodes, comprising:
receiving network topology information;
receiving a definition of a subset of network nodes from which to collect data and a definition of the type of data to collect;
generating collection configuration information in response to the network topology information, definition of the subset of network nodes and definition of the type of data; and
collecting data from the subset of network nodes according to the collection configuration information.

11. The method, as set forth in claim 10, wherein receiving the network topology information comprises receiving identities of the subset of network nodes requiring monitoring.

12. The method, as set forth in claim 10, wherein receiving the network topology information comprises receiving identities of active network nodes existing in the network.

13. The method, as set forth in claim 10, wherein receiving a definition of a subset of network nodes from which to collect data comprises receiving a range of Internet Protocol addresses of the subset of network nodes.

14. The method, as set forth in claim 10, wherein receiving a definition of a subset of network nodes from which to collect data comprises receiving a device type of the subset of network nodes.

15. The method, as set forth in claim 10, wherein receiving a definition of a subset of network nodes from which to collect data comprises receiving a predetermined criteria to define the subset of the network nodes.

16. The method, as set forth in claim 10, wherein receiving a definition of the type of data to collect comprises receiving an identification of a data type to collect from the subset of network nodes requiring monitoring.

17. The method, as set forth in claim 10, wherein receiving a definition of the type of data to collect comprises receiving a definition of a timing related to the collection of the data from the subset of network nodes requiring monitoring.

18. The method, as set forth in claim 10, wherein receiving a definition of the type of data to collect comprises receiving a definition of how to store the collected data from the subset of network nodes requiring monitoring.

19. The method, as set forth in claim 10, further comprising providing the generated collection configuration information to at least one collector operable to collect the data from the subset of network nodes requiring monitoring.

20. A system for network fault monitoring, comprising:
means for receiving network topology information;
means for receiving a definition of a subset of network nodes from which to collect data and a definition of the type of data to collect;
means for generating collection configuration information in response to the network topology information, definition of the subset of network nodes and definition of the type of data; and
means for collecting data from the subset of network nodes according to the collection configuration information.

21. The system, as set forth in claim 20, wherein means for receiving the network topology information comprises means for receiving identities of the subset of network nodes requiring monitoring.

22. The system, as set forth in claim 20, wherein means for receiving a definition of a subset of nodes comprises means for receiving a device type of the subset of network nodes.

23. The system, as set forth in claim 20, wherein means for receiving a definition of the type of data to collect comprises means for receiving an identification of a data type to collect from the subset of network nodes requiring monitoring.
